(19) United States
(12) Patent Application Publication
(10) Pub. No.: US 2003/0220821 A1
(43) Pub. Date: Nov. 27, 2003

(54) System and method for managing and reconciling asynchronous patient data

(76) Inventors: Ervin Walter, Madison, WI (US); Andy Giesler, Madison, WI (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/428,039

(22) Filed: Apr. 30, 2003

Related U.S. Application Data
(60) Provisional application No. 60/376,632, filed on Apr. 30, 2002.

(51) Int. Cl. G06F 17/60

(52) U.S. Cl. 705/3

(57) ABSTRACT

A method of managing asynchronous patient data in a healthcare setting including entering into an asynchronous operation between a client device and a patient health record repository, requesting access to a portion of a source patient health record, opening a temporary, unresolved patient health record, and modifying and saving the temporary record. The method also includes establishing a subsequent synchronous connection, submitting the temporary record to the repository for resolution, determining whether the temporary record can be matched to the source record in the repository, creating a new source record for the temporary record and deleting the temporary record if a match for the temporary record is not found in the repository. The method also includes updating the source record, and deleting the temporary record.

### CROSS-REFERENCE TO RELATED APPLICATION

This application claims priority to U.S. Provisional Application Serial No. 60/376,632, entitled “System and Method for Managing and Reconciling Asynchronous Patient Data,” filed Apr. 30, 2002 (attorney docket no. 29794/38270), the disclosure of which is hereby expressly incorporated herein by reference.

### TECHNICAL FIELD

This patent relates generally to healthcare information systems, and more particularly, to a system for managing patient data in asynchronous environments and a method for reconciling asynchronous patient data with patient data housed in a patient data repository.

### BACKGROUND

The management of patient data in asynchronous environments presents a significant challenge for software development. An asynchronous environment, taken within the context of a healthcare information system, may take at least two common forms. In a first form, a healthcare information system may permit asynchronous conditions that take the form of temporary, unresolved patient health records. These records may be created and stored by client applications running on a number of device types, including but not limited to handheld devices, laptop devices, and workstations.

Client applications may create and store these temporary, unresolved patient records when a user requires access to a given patient health record at a time when that record is not available to the client application via a live, real-time connection to a patient health record repository and is also not available locally. In this case, the entire temporary patient record is subject to resolution when the client application is once again able to communicate directly with the patient health record repository.

In a second form, a healthcare information system may permit asynchronous conditions that take the form of patient health records that contain data values that require resolution with the patient health record repository. These records may be modified or edited by client applications running on a number of device types, including but not limited to handheld devices, laptop devices, and workstations.

Client applications would modify and store these patient records when a user requires access to a given patient health record that is available locally to the client application but not via a live, real-time connection to the patient health record repository. In this case, the entire temporary patient record does not require resolution. Instead, when the client application is once again able to communicate directly with the patient health record repository, the data items that have been modified are subject to resolution.

Operating in an asynchronous environment implies that a given patient record or piece of patient data may not be represented on or available to the client application in real time. The asynchronous conditions may have arisen because of a lost or interrupted connection between the client application and the patient health record repository, because the client application could not establish the appropriate connection so that it could access the appropriate patient data, or because the client application is configured in such a way that it does not depend on a real-time connection to the patient health record repository to function appropriately. An asynchronous environment necessitates one of two responses: the end-user is either prevented from working with a given patient because a real-time connection to the patient health record repository does not exist, or the end-user is allowed to perform certain tasks with an unresolved version of the given patient record or a temporary, unresolved patient record, which will then be subject to later resolution with the data in the patient health record repository when a connection becomes available.

### SUMMARY

The present patent overcomes the disadvantages of the prior art by providing a system for the collection of temporary patient data using applications operating in an asynchronous environment and a method for reconciling asynchronous patient data stored by the applications with patient data stored in a patient health record repository. The system includes a mechanism for capturing patient data in temporary, unresolved patient records and a method that defines the manner in which these temporary, unresolved patient records are reconciled with the patient data stored in the patient health record repository.

In another aspect of the patent, a system is provided for the collection of patient data in temporary unresolved patient records for operation in asynchronous environments, either by allowing for the creation of unresolved patient data based on a locally available version of the desired patient record (item-level), or by creating a new, temporary, unresolved patient record (record-level).

In yet another aspect of the patent, a method is disclosed for resolving one or more temporary patient records with the patient health record repository that combines duplicate checking functionality, an architecture of rules and rule relationships for solving data conflicts, and a resolution work queue that allows users to perform both record-level and item-level resolutions.

In another aspect of the patent, a client application running on a handheld device may be configured to communicate with the patient health record repository either via a real-time, wireless connection or via an intermittently-used wired connection, such as a cradle device or docking device. This client application could operate in an asynchronous environment if the real-time, wireless connection was temporarily lost, as well as when the handheld device is not physically connected to the patient health record repository via the intermittently-used wired connection.

Such a client application could allow users to create temporary, unresolved patient records to represent patient data that is not available locally when the real-time connection to the patient health record repository does not exist. In addition, such a client application could allow users to modify data within patient health records that are available locally when the real-time connection to the patient health record repository does not exist. When the connection between the client application and the patient health record repository becomes available, either as a real-time wireless connection or via an intermittently-used wired connection such as a cradle device or docking device, both the temporary unresolved patient records and the patient records with modified data items may be subject to resolution.

Another aspect of the patent allows a client application running on a laptop device to be configured to communicate with the patient health record repository either via a real-time, wireless connection or via an intermittently-used wired connection, such as a docking device or a network port. This client application would operate in an asynchronous environment if the real-time wireless connection was temporarily lost, as well as when the laptop device was not physically connected to the patient health record repository via the intermittently-used wired connection.

Such a client application could allow users to create temporary, unresolved patient records to represent patient data that is not available locally when the real-time connection to the patient health record repository does not exist. In addition, such a client application could allow users to modify data within patient health records that are available locally when the real-time connection to the patient health record repository does not exist. When the connection between the client application and the patient health record repository becomes available, either as a real-time wireless connection or via an intermittently-used wireless connection such as a docking device or a network port, both the temporary unresolved patient records and the patient records with modified data items may be subject to resolution.

In another aspect of the patent, a client application running on a workstation that is normally in constant, real-time communication with the patient health record repository via a network port (or some other analogous connection) may also be configured to function in an asynchronous environment. This client application could operate in an asynchronous environment if the real-time connection with the patient health record repository was temporarily lost or interrupted (due to network conditions, server loads, etc.).

Such a client application could allow users to create temporary, unresolved patient records to represent patient data that is not available locally when the real-time connection to the patient health record repository is lost or interrupted. In addition, such a client application could allow users to modify data within patient health records that are available locally when the real-time connection to the patient health record repository is lost or interrupted. When the connection between the client application and the patient health record repository is restored, both the temporary unresolved patient records and the patient records with modified data items may be subject to resolution.

In short, the present patent describes a system for managing patient data in asynchronous environments and a method for reconciling asynchronous patient data with patient data housed in a central patient data repository.

### BRIEF DESCRIPTION OF THE DRAWINGS

FIG. 1 is a block diagram of a general purpose data network.

FIG. 2 is a schematic diagram of an embodiment of a network computer.

FIG. 3 is a schematic diagram of several system components located in a healthcare facility.

FIG. 4 is a block diagram of an overview of a healthcare information system operating in synchronous mode.

FIG. 5 is a block diagram of an exemplary mobile handheld dictation system.

FIG. 6 is a flowchart illustrating some of the steps used in the collection of unresolved patient data.

FIG. 7 is a flowchart representing some of the steps used for item-level resolution.

FIG. 8 is a flowchart representing some of the steps that may be used for record-level resolution.

### DETAILED DESCRIPTION

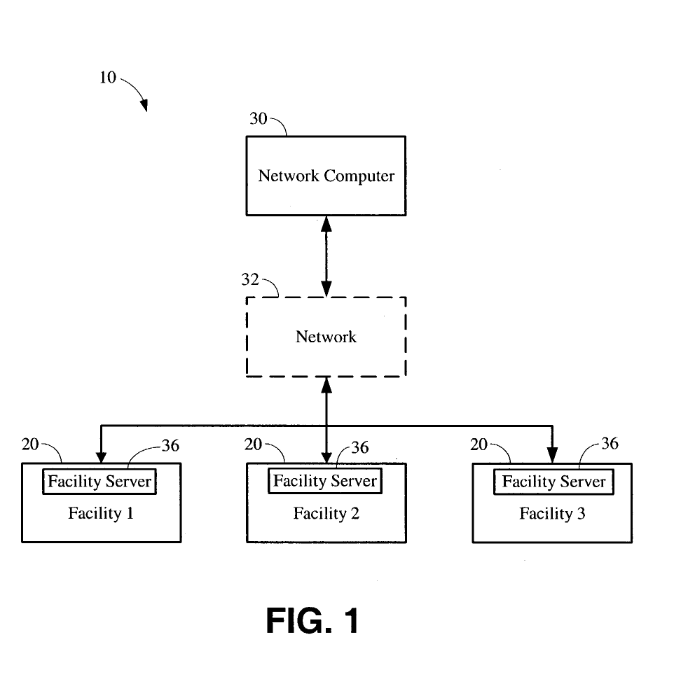

FIG. 1 illustrates an embodiment of an enterprise-wide data network 10 including a first group of healthcare facilities 20 operatively coupled to a network computer (i.e. machine) 30 via a network 32. The plurality of healthcare facilities 20 may be located, by way of example rather than limitation, in separate geographic locations from each other, in different areas of the same city, or in different states. The network 32 may be provided using a wide variety of techniques well known to those skilled in the art for the transfer of electronic data. For example, the network 32 may comprise dedicated access lines, plain ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download data relating to a healthcare facility's medical records. For example, the network computer 30 may periodically receive data from each of the healthcare facilities 20 indicative of information pertaining to a patient's medical record, billing information, employee data, etc. The healthcare facilities 20 may include one or more facility servers 36 that may be utilized to store information for a plurality of patients/employees/accounts/etc. associated with each facility.

Although the enterprise-wide data network 10 is shown to include one network computer 30 and three healthcare facilities 20, it should be understood that different numbers of computers and healthcare facilities may be utilized. For example, the network 32 may include a plurality of network computers 30 and dozens of healthcare facilities 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in the process of updating and accumulating healthcare data.

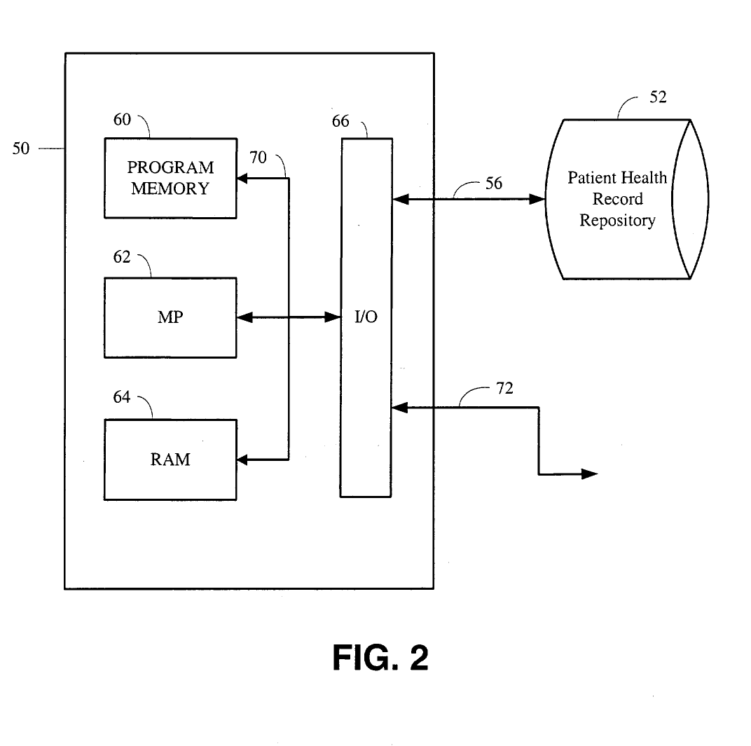

FIG. 2 is a schematic diagram of one possible embodiment of the network computer (i.e. machine) 30 shown in FIG. 1. The network computer 30 may have a controller 50 that is operatively connected to a patient health record repository 52 (such as a Universal Patient Record repository) via a link 56. The patient health record repository 52 may include one or more databases or data repositories that store patient healthcare data and related healthcare business data using one or more database management systems that run on one or more computing platforms on one or more computing devices. It should be noted that, while not shown, any additional databases or repositories may be linked to the controller 50 in a similar manner.

The controller may include a program memory 60, a microcontroller or a microprocessor (MP) 62, a random-access memory (RAM) 64, and an input/output (I/O) circuit 66, all of which may be interconnected via an address/data bus 70. It should be appreciated that although only one microprocessor 62 is shown, the controller 50 may include multiple microprocessors 62. Similarly, the memory of the controller 50 may include multiple RAMs 64 and multiple program memories 60. Although the I/O circuit 66 is shown as a single block, it should be appreciated that the I/O circuit 66 may include a number of different types of I/O circuits. The RAM(s) 64 and programs memories 60 may be implemented as semiconductor memories, magnetically readable memories, and/or optically readable memories, for example. The controller 50 may also be operatively connected to the network 32 via a link 72.

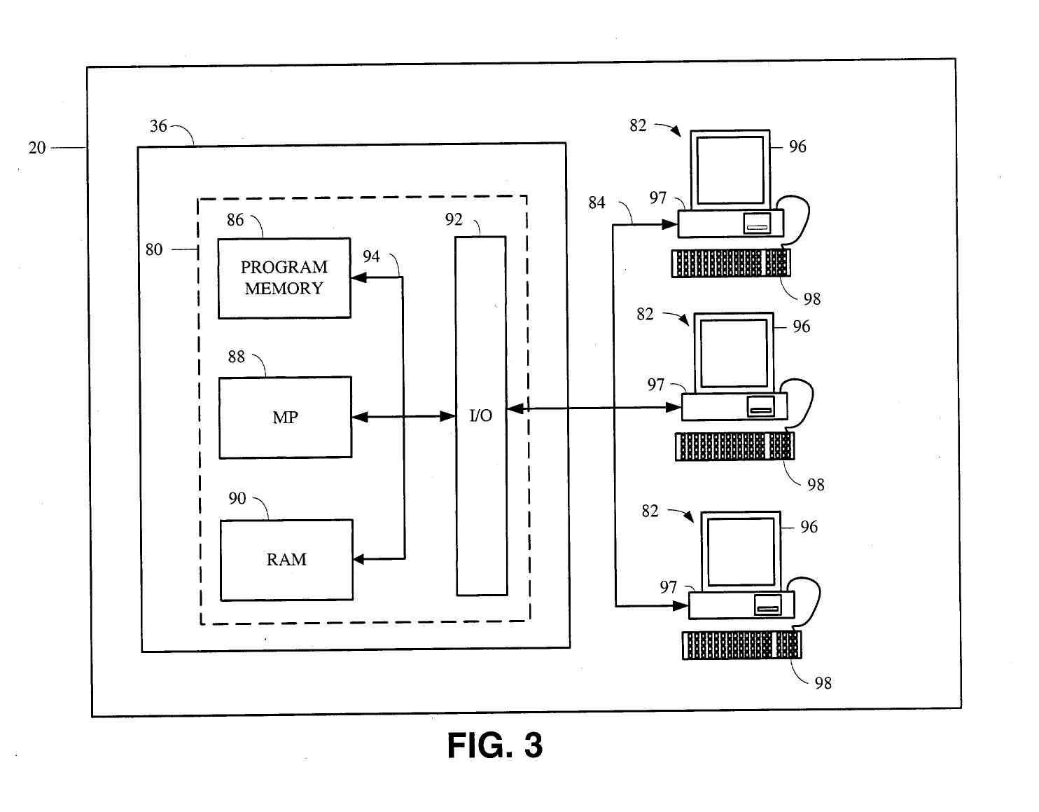

FIG. 3 is a schematic diagram of one possible embodiment of several components located in one or more of the healthcare facilities 20 from FIG. 1. Although the following description addresses the design of the healthcare facilities 20, it should be understood that the design of one or more of the healthcare facilities 20 may be different than the design of other healthcare facilities 20. Also, each healthcare facility 20 may have various different structures and methods of operation. It should also be understood that the embodiment shown in FIG. 3 illustrates some of the components and data connections present in a healthcare facility, however it does not illustrate all of the data connections present in a typical healthcare facility. For exemplary purposes, one design of a healthcare facility is described below, but it should be understood that numerous other designs may be utilized.

The healthcare facilities 20 may have a facility server 36, which includes a controller 80, wherein the facility server 36 is operatively connected to a plurality of client device terminals 82 via a network 84. The network 84 may be a wide area network (WAN), a local area network (LAN), or any other type of network readily known to those persons skilled in the art. The client device terminals 82 may also be operatively connected to the network computer 30 from FIG. 1 via the network 32. The client device terminals 82 as well as the facility server 36 may be referred to as machines for the purposes of this patent.

Similar to the controller 50 from FIG. 2, the controller 80 may include a program memory 86, a microcontroller or a microprocessor (MP) 88, a random-access memory (RAM) 90, and an input/output (I/O) circuit 92, all of which may be interconnected via an address/data bus 94. As discussed with reference to the controller 50, it should be appreciated that although only one microprocessor 88 is shown, the controller 80 may include multiple microprocessors 88. Similarly, the memory of the controller 80 may include multiple RAMs 90 and multiple programs memories 86. Although the I/O circuit 92 is shown as a single block, the I/O circuit 92 may include a number of different types of I/O circuits. The RAM(s) 90 and programs memories 86 may also be implemented as semiconductor memories, magnetically readable memories, and/or optically readable memories, for example. All of these memories or data repositories may be referred to as machine-accessible mediums.

The client device terminals 82 may include a display 96, a controller 97, a keyboard 98 as well as a variety of other input/output devices (not shown) such as a printer, mouse, touch screen, track pad, track ball, isopoint, voice recognition system, etc. Each client device terminal 82 may be signed onto and occupied by a healthcare employee to assist them in performing their duties. Healthcare employees may sign onto a client device terminal 82 using any generically available technique, such as entering a user name and password. If a healthcare employee is required to sign onto a client device terminal 82, this information may be passed via the link 84 to the facility server 36, so that the controller 80 will be able to identify which healthcare employees are signed onto the system and which client device terminals 82 the employees are signed onto. This may be useful in monitoring the healthcare employees' productivity.

Typically, facility servers 36 store a plurality of files, programs, and other data for use by the client device terminals 82 and the network computer 30. One facility server 36 may handle requests for data from a large number of client device terminals 82. Accordingly, each facility server 36 may typically comprise a high end computer with a large storage capacity, one or more fast microprocessors, and one or more high speed network connections. Conversely, relative to a typical facility server 36, each client device terminal 82 may typically include less storage capacity, a single microprocessor, and a single network connection.

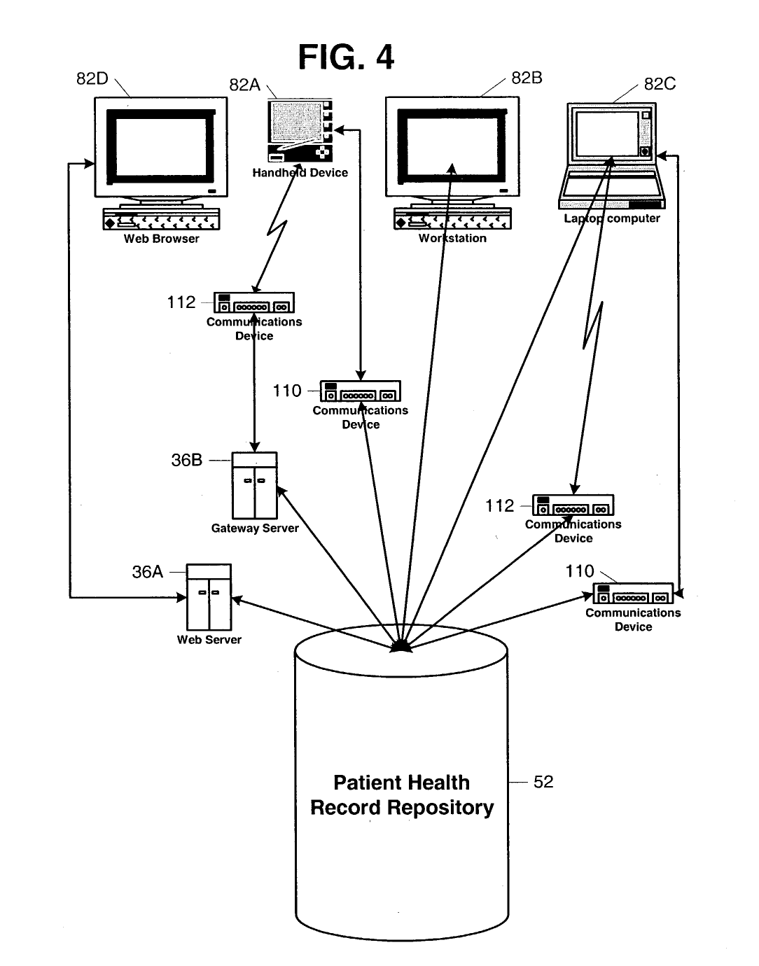

FIG. 4 is a block diagram of a health care information system operating in a synchronous mode. Such a system may include the patient health record repository 52, as well as client applications running on a handheld device 82A, a workstation 82B, and a laptop computer 82C. These client applications communicate with the patient health record repository 52 via a web server 36A (if the client application is a web browser 82D). The client applications may also communicate with the patient health record repository 52 via one or more gateway servers (if the client application is running on the wireless handheld device 82A with a real-time, wireless connection), such as a gateway server 36B. Connection to the patient health record repository 52 may also be made using wired communications devices 110 (used intermittently to connect handheld devices and laptop devices to the system), and wireless communications devices 112 (used to facilitate real-time, wireless connections between handheld devices and handheld devices with other system components).

Client applications running on workstations and laptop computers may also communicate directly with the patient health record repository 52 via standard, wired network connections and protocols. Such a system is said to operate in a synchronous mode because each of these connections is continually available, thus allowing a client application immediate access to a given patient health record and includes the ability to lock patient health records so that only a single user or process can edit the record's data at a given time.

### Overall Operation of the System

One manner in which an exemplary system may operate is described below in connection with a block diagram overview and a number of flow charts which represent a number of portions or routines of one or more computer programs. These computer program portions may be stored in one or more of the memories in the controllers 50 and 80, and may be written at any high level language such as C, C++, or the like, or any low-level, assembly or machine language. By storing the computer program portions therein, various portions of the memories are physically and/or structurally configured in accordance with the computer program instructions.

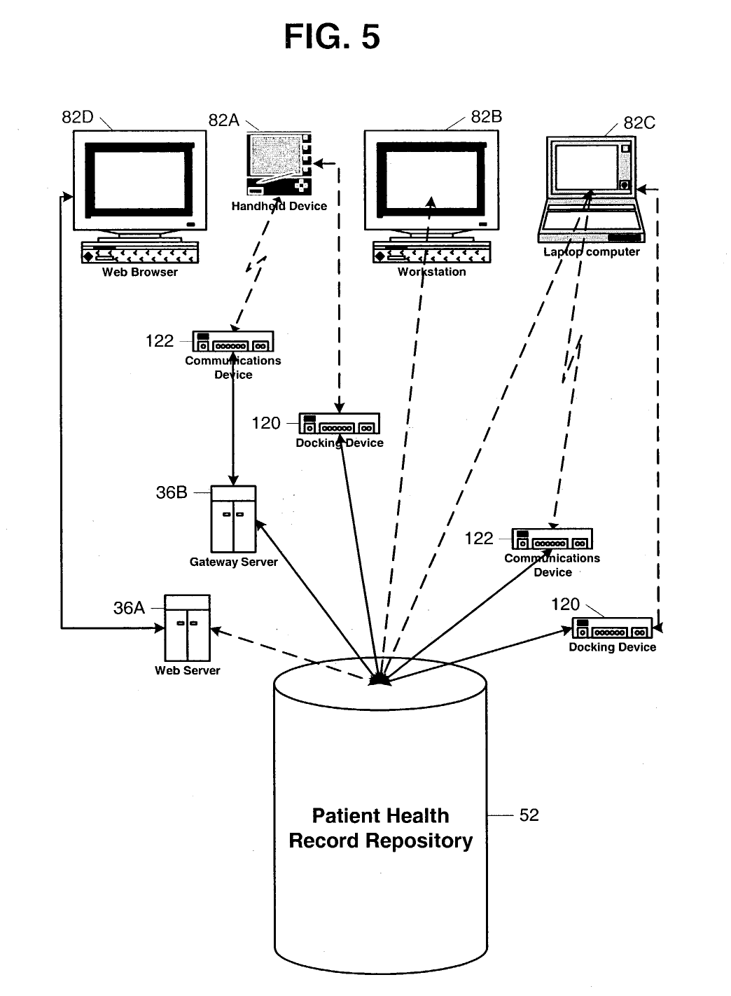

FIG. 5 is a block diagram overview of an exemplary health care information system operating in an asynchronous mode. The embodiment of FIG. 5 is similar to the embodiment shown in FIG. 4 and includes many of the same structures and components. For clarity, the structures and components remaining the same are shown with like reference numbers as those from FIG. 4. An asynchronous environment includes a system configuration characterized by the lack of a continuous, real-time connection between a client application and the patient health record repository 52, while allowing users to manipulate patient data and healthcare business data even when a real-time connection does not currently exist.

Referring to FIG. 5, the system may include the patient health record repository 52, as well as client applications running on the handheld device 82A, a workstation 82B, and a laptop computer 82C. Persons skilled in the art will appreciate that while only one computing device of each type 82A, 82B, and 82C is shown, a plurality of the devices 82A, 82B, and 82C, as well as other types of computing devices could be used. The client applications may communicate with the patient health record repository 52 via a web server 36A (if the client application is a web browser 82D). The client applications may also communicate with the patient health record repository 52 via one or more gateway servers (if the client application is running on the wireless handheld device 82A with a real-time, wireless connection), such as a gateway server 36B. Those skilled in the art will appreciate that the enterprise may include other types of servers as well, such as, for example, application servers and database servers. Connection to the patient health record repository 52 may also be made using wired communications devices 120 (used intermittently to connect handheld devices and laptop devices to the system), and wireless communications devices 122 (used to facilitate real-time, wireless connections between handheld devices and handheld devices with other system components).

Client applications running on workstations and laptop computers may also communicate directly with the patient health record repository 52 via standard, wired network connections and protocols. Such a system is said to operate in an asynchronous mode because of the aforementioned connections between the client applications and the patient health record repository 52 may not exist continually. This situation, in combination with the client application's ability to create temporary, unresolved patient records locally and to edit patient records that are already locally available, allows for multiple versions of the same patient health record to exist temporally and geographically.

The network connections described above may take place over a computer network that includes industry standard network hardware (routers, switches, connectors, etc.) and software (network and communication protocols) that serve to allow communication between the patient health record repository 52, the end-user client applications running on various device types, and the various types of servers. This network may take the form of a cable-based or fiber optic network, a wireless local area network (LAN), a wireless wide area network (WAN), a virtual private network (VPN), the Internet, or any other type of wired or wireless network that allows communication between computing devices.

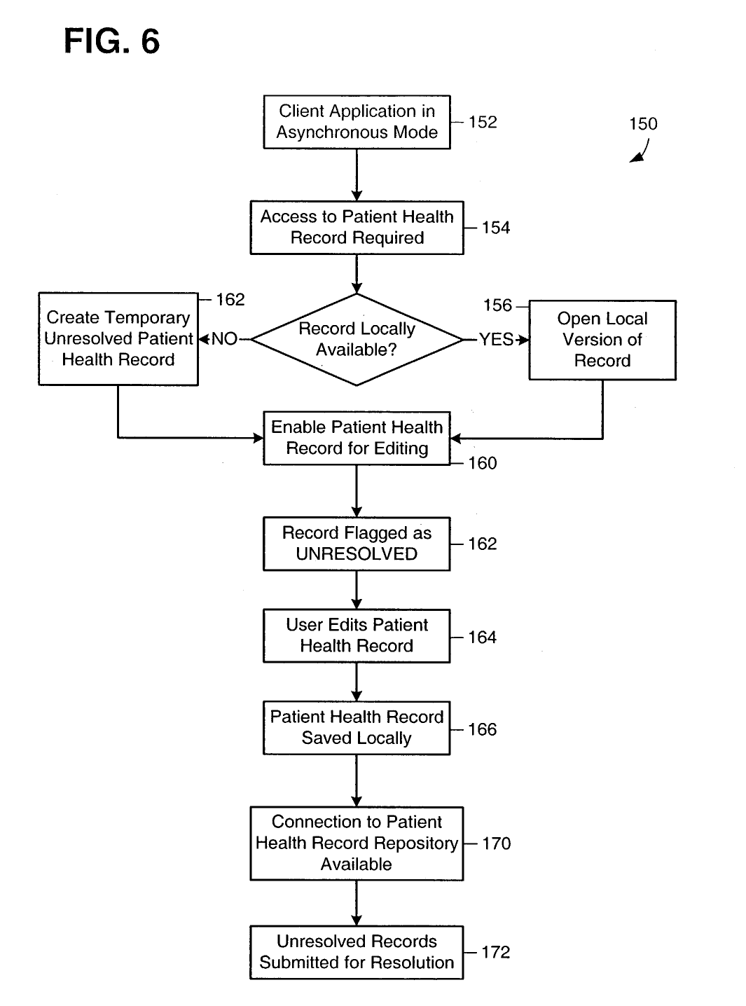

FIG. 6 is a flowchart 150 illustrating some of the steps in a client application for collecting of unresolved patient data. When the client application is operating in an asynchronous mode, it may be configured to allow for the collection of unresolved patient data (block 152). If configured to allow for the collection of unresolved patient data, the user can then attempt to gain access to a given patient health record (block 154). If the patient health record, or the applicable portion of the record, is available locally, the client application may open a local version of the patient record (block 156), and make it, or some portion of it, available for editing (block 160).

If the record in question, or the applicable portion of the record, is not available locally, the client application may create a temporary, unresolved patient health record (block 162), and make it, or some portion of it, available for editing (block 160). In addition, the client application may mark the record as unresolved, so that when the client application can communicate with the patient health record repository in real time, the record can be submitted for resolution.

If the record being marked as unresolved was available locally, it may be marked for item-level resolution. If the record is a new, temporary, unresolved patient record, it may be marked for record-level resolution. After the user edits or modifies the patient health record in question (block 164), or at least a portion of the patient health record in question, the client application may save the record locally (block 166). When the client application can once again communicate with the patient health record repository in real time (block 170), each of the records marked for resolution are submitted to the patient health record repository for resolution (block 172).

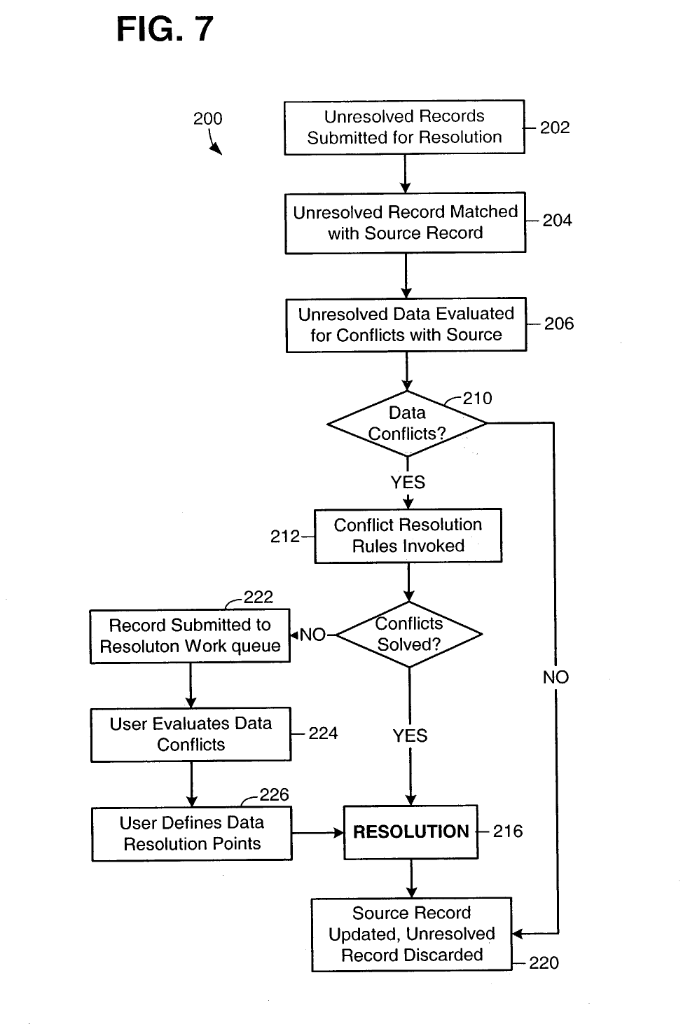

FIG. 7 is a flow chart 200 illustrating some of the steps that may be used for item-level resolution. When a patient health record marked for item-level resolution is submitted for resolution (block 202), the unresolved patient record may be matched with the corresponding source record (block 204) and the unresolved-data may be evaluated to determine if data conflicts exist between the source record and the unresolved record (block 206). If no conflicts exist, the source record may be updated and the unresolved record discarded.

Data conflicts may be checked at a block 210. If data conflicts do exist, each point of data conflict may be examined in light of one or more conflict resolution rules (block 212). If it is determined at a block 214 that the application of one or more conflict resolution rules solves all of the data conflicts, the conflicts may be considered resolved (block 216) and the source record updated accordingly (block 220). If all the data conflicts cannot be solved by the application of one or more conflict resolution rules, the unresolved patient health record may be submitted to a resolution work queue for later examination (block 222), where it may remain until a user evaluates the remaining data conflicts (block 224), and determines a solution for these conflicts. Once the user has determined a solution for each data conflict in a given record (block 226), the conflicts may be considered resolved (block 216) and the source record updated accordingly (block 220). After the source record is updated, the unresolved version of the record may be discarded.

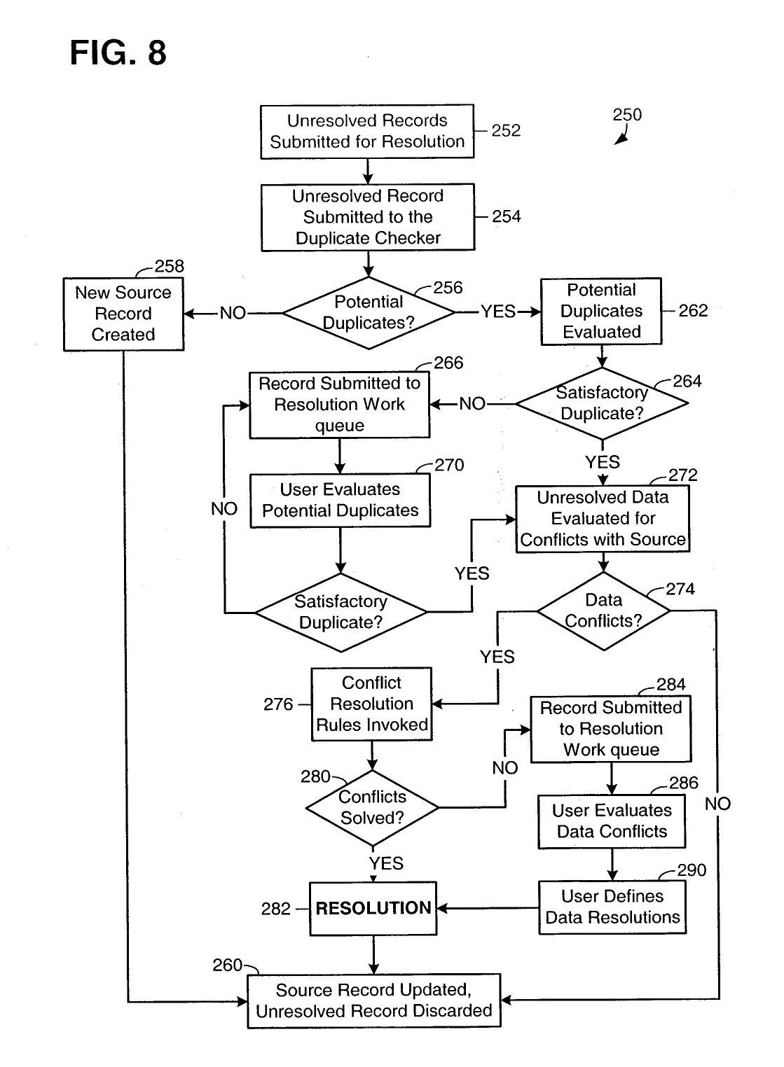

FIG. 8 is a flow chart 250 representing some of the steps that may be used for record-level resolution. When a patient health record marked for record-level resolution is submitted for resolution (block 252), the temporary, unresolved patient record may be submitted to a duplicate checker to determine whether the unresolved record can be automatically matched to its corresponding source record, according to one or more criteria (block 254). If it is determined at a block 256 that no potential duplicates are found, the system may create a new record in the patient health record repository (block 258) and transfer the data from the temporary, unresolved record to this new, source record and discard the unresolved record (block 260). If there are potential matches provided by the duplicate checker (block 262), the system may determine whether the matches between any potential duplicate and the temporary, unresolved record exceed a pre-defined threshold that indicates a satisfactory match (block 264).

If a satisfactory match does not exist, the unresolved record may be submitted to a resolution work queue for later examination (block 266), where it may remain until a user evaluates the potential matches produced by the duplicate checking process (block 270). If the user is able to satisfactorily associate a source record with the unresolved record, the records may be evaluated to determine whether data conflicts exist between the source record and the unresolved record (block 272). If it is determined at a block 274 that no data conflicts exist, the source record may be updated accordingly and the unresolved record discarded (block 260).

If data conflicts do exist, each point of data conflict may be examined in the light of one or more conflict resolution rules (block 276). If it is determined at a block 280 that the application of one or more conflict resolution rules solves all of these data conflicts, the conflicts may be considered resolved (block 282) and the source record updated accordingly (block 260). If it is determined at a block 280 that all the data conflicts cannot be solved by the application of one or more conflict resolution rules, the unresolved patient health record may remain in the resolution work queue (block 284) until a user evaluates the remaining data conflicts (block 286). Once the user has determined a solution for each data conflict in a given record (block 290), the conflicts may be considered resolved (block 282) and the source record may be updated accordingly (block 260). After the source record is updated, the unresolved version of the record may be discarded.

Returning to the block 264, if it is determined that a satisfactory match exists, the records may be evaluated to determine whether data conflicts exist between the source record and the unresolved record (block 272). If no data conflicts exist, the source record may be updated accordingly and the unresolved record may be discarded (block 260). If data conflicts do exist, each point of data conflict may be examined in the light of one or more conflict resolution rules (block 276). If the application of one or more conflict resolution rules solves all of the data conflicts, the conflicts may be considered-resolved (block 282) and the source record may be updated accordingly (block 260).

If all the data conflicts cannot be solved by the application of one or more conflict resolution rules, the unresolved patient health record may be submitted to a resolution work queue for later examination (block 284), where it may remain until a user evaluates the remaining data conflicts (block 286). Once the user has determined a solution for each data conflict in a given record (block 290), the conflicts may be considered resolved (block 282) and the source record may be updated accordingly (block 260). After the source record is updated, the unresolved version of the record may be discarded.

Although the technique for reconciling asynchronous patient data described herein, is preferably implemented in software, it may be implemented in hardware, firmware, etc., and may be implemented by any other processor associated with a healthcare enterprise. Thus, the routine(s) described herein may be implemented in a standard multi-purpose CPU or on specifically designed hardware or firmware as desired. When implemented in software, the software routine(s) may be stored in any computer readable memory such as on a magnetic disk, a laser disk, or other storage medium, in a RAM or ROM of a computer or processor, etc. Likewise, the software may be delivered to a user or process control system via any known or desired delivery method including, for example, on a computer readable disk or other transportable computer storage mechanism or over a communication channel such as a telephone line, the Internet, etc. (which are viewed as being the same as or interchangeable with providing such software via transportable storage medium).

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

What is claimed is:

1. A method of managing asynchronous patient data in a healthcare setting comprising:
entering into an asynchronous operation between a client device and a patient health record repository when required by a system communication need, the patient health record repository storing a source patient health record;
requesting access to a portion of the source patient health record using the client device;
opening a temporary, unresolved patient health record;
modifying the requested portion of the temporary, unresolved patient health record;
saving the modified temporary, unresolved patient health record;
establishing a synchronous connection between the client device and the patient health record repository;
submitting the temporary, unresolved patient health record to the patient health record repository for resolution;
determining whether the temporary, unresolved patient health record can be matched to the source patient health record in the patient health record repository;
creating a new source patient health record for the temporary, unresolved patient health record and deleting the temporary, unresolved patient health record if a match for the temporary, unresolved patient health record is not found in the patient health record repository; and
updating the source patient health record, and deleting the temporary, unresolved patient health record.

2. The method of claim 1, comprising marking the temporary, unresolved patient health record as unresolved.

3. The method of claim 1, wherein opening the temporary, unresolved patient health record comprises opening a local version of the source patient health record.

4. The method of claim 1, wherein opening the temporary, unresolved patient health record comprises creating the temporary, unresolved patient health record when the requested portion of the source patient health record is not available locally.

5. The method of claim 1, comprising identifying a data conflict between the source patient health record and the temporary, unresolved patient health record if a match for the temporary, unresolved patient health record is found in the patient health record repository and invoking a conflict resolution rule to resolve the data conflict.

6. The method of claim 5, comprising determining whether the match between the source patient health record and the temporary, unresolved patient health record exceed a pre-defined threshold that indicates a satisfactory match.

7. The method of claim 6, comprising submitting the temporary, unresolved patient health record to a resolution work queue for later evaluation by a user.

8. The method of claim 5, comprising submitting the temporary, unresolved patient health record to a resolution work queue for later evaluation by a user when the conflict resolution rule does not resolve the data conflict.

9. The method of claim 8, comprising allowing the user to perform both a record-level resolution and an item-level resolution.

10. A method of managing asynchronous patient data in a healthcare setting comprising:
entering into an asynchronous operation between a client device and a patient health record repository, the patient health record repository storing a source patient health record;
requesting access to a portion of the source patient health record using the client device;
opening a corresponding local temporary unresolved patient health record;
modifying the requested portion of the local temporary unresolved patient health record;
saving the modified local temporary unresolved patient health record;
establishing a synchronous connection between the client device and the patient health record repository;
submitting the local temporary unresolved patient health record to the patient health record repository for resolution;
matching the local temporary unresolved patient health record to the source patient health record in the patient health record repository;
updating the source patient health record; and
deleting the local temporary unresolved patient health record.

11. The method of claim 10, comprising entering into the asynchronous operation when required by a system communication need.

12. The method of claim 10, comprising marking the local temporary unresolved patient health record as unresolved.

13. The method of claim 10, comprising identifying a data conflict between the source patient health record and the local temporary unresolved patient health record, and invoking a conflict resolution rule to resolve the data conflict.

14. The method of claim 13, comprising submitting the local temporary unresolved patient health record to a resolution work queue for later evaluation by a user when the conflict resolution rule does not resolve the data conflict.

15. The method of claim 13, comprising allowing the user to perform an item-level resolution.

16. A method of managing asynchronous patient data in a healthcare setting comprising:
entering into an asynchronous operation between a client device and a patient health record repository, the patient health record repository storing a source patient health record;
creating a temporary, unresolved patient health record;
saving the temporary, unresolved patient health record;
establishing a synchronous connection between the client device and the patient health record repository;
submitting the temporary, unresolved patient health record to the patient health record repository for resolution;
determining whether the temporary, unresolved patient health record can be matched to the source patient health record in the patient health record repository;
saving the temporary, unresolved patient health record as a new source patient health record in the patient health record repository and deleting the temporary, unresolved patient health record if a match for the temporary, unresolved patient health record is not found in the patient health record repository; and
performing a number of actions if a match for the temporary, unresolved patient health record is found in the patient health record repository, including:
updating the source patient health record; and
deleting the temporary, unresolved patient health record.

17. The method of claim 16, comprising entering into the asynchronous operation when required by a system communication need.

18. The method of claim 16, comprising marking the temporary unresolved patient health record as unresolved.

19. The method of claim 16, wherein performing the number of actions comprises identifying a data conflict between the source patient health record and the temporary, unresolved patient health record, and invoking a conflict resolution rule to resolve the data conflict.

20. The method of claim 19, comprising submitting the temporary unresolved patient health record to a resolution work queue for later evaluation by a user when the conflict resolution rule does not resolve the data conflict.

21. The method of claim 20, comprising allowing the user to perform a record-level resolution.

22. The method of claim 16, comprising determining whether the match between the source patient health record and the temporary, unresolved patient health record exceed a pre-defined threshold that indicates a satisfactory match.

23. The method of claim 22, comprising submitting the temporary unresolved patient health record to a resolution work queue for later evaluation by a user when the match does not indicate a satisfactory match.

24. A system for managing asynchronous patient data in a healthcare setting comprising:
means for entering into an asynchronous operation between a client device and a database when required by a system communication need, the database storing a source patient health record;
means for requesting access to a portion of the source patient health record using the client device;
means for opening a temporary, unresolved patient health record;
means for modifying the requested portion of the temporary, unresolved patient health record;
means for saving the modified temporary, unresolved patient health record;
means for submitting the temporary, unresolved patient health record to the database for resolution;
means for determining whether the temporary, unresolved patient health record can be matched to the source patient health record in database;
means for creating a new source patient health record for the temporary, unresolved patient health record and deleting the temporary, unresolved patient health record if a match for the temporary, unresolved patient health record is not found in the database;
means for updating the source patient health record; and
means for deleting the temporary, unresolved patient health record.

25. The system of claim 24, comprising means for marking the temporary, unresolved patient health record as unresolved.

26. The system of claim 24, wherein opening the temporary, unresolved patient health record comprises a means for opening a local version of the source patient health record.

27. The system of claim 24, wherein opening the temporary, unresolved patient health record comprises a means for creating the temporary, unresolved patient health record when the requested portion of the source patient health record is not available locally.

28. The system of claim 24, comprising means for identifying a data conflict between the source patient health record and the temporary, unresolved patient health record if a match for the temporary, unresolved patient health record is found in the database, and means for invoking a conflict resolution rule to resolve the data conflict.

29. The system of claim 28, comprising means for determining whether the match between the source patient health record and the temporary, unresolved patient health record exceed a pre-defined threshold that indicates a satisfactory match.

30. The system of claim 28, comprising means for submitting the temporary, unresolved patient health record to a resolution work queue for later evaluation by a user when the conflict resolution rule does not resolve the data conflict.

31. The system of claim 28, comprising means for allowing the user to perform both a record-level resolution and an item-level resolution.

32. The system of claim 24, comprising means for establishing a synchronous connection between the client device and database.

33. An article comprising a machine-accessible medium having stored thereon instructions that, when executed by a machine, cause the machine to:
enter into an asynchronous operation between a client device and a patient health record repository, wherein the patient health record repository is configured to store a source patient health record;
request access to a portion of the source patient health record using the client device;
open a corresponding local temporary unresolved patient health record;
modify the requested portion of the local temporary unresolved patient health record;
save the modified local temporary unresolved patient health record;
establish a synchronous connection between the client device and the patient health record repository;
submit the local temporary unresolved patient health record to the patient health record repository for resolution;
match the local temporary unresolved patient health record to the source patient health record in the patient health record repository;
update the source patient health record; and
delete the local temporary unresolved patient health record.

34. The article of claim 33, having further instructions that, when executed by the machine, cause the machine to enter into the asynchronous operation when required by a system communication need.

35. The article of claim 33, having further instructions that, when executed by the machine, cause the machine to mark the local temporary unresolved patient health record as unresolved.

36. The article of claim 33, having further instructions that, when executed by the machine, cause the machine to identify a data conflict between the source patient health record and the local temporary unresolved patient health record and invoke a conflict resolution rule to resolve the data conflict.

37. The article of claim 34, having further instructions that, when executed by the machine, cause the machine to submit the local temporary unresolved patient health record to a resolution work queue for later evaluation by a user when the conflict resolution rule does not resolve the data conflict.

38. The article of claim 34, having further instructions that, when executed by the machine, cause the machine to allow the user to perform an item-level resolution.

39. A method of managing asynchronous patient data in a heal thc are setting comprising:
providing an asynchronous mode of operation in a client device responsive to an unavailability of a synchronous connection to a patient health record;
opening a temporary, unresolved patient health record;
receiving a modification to a portion of the temporary, unresolved patient health record to create a modified, temporary unresolved patient health record;
communicating the modified, temporary, unresolved patient health record to a patient health record repository for resolution;
receiving an acknowledgement of resolution of the patient health record, the acknowledgment being an indication that the patient health record has been resolved in accordance with a resolution criteria; and
deleting the modified, temporary unresolved patient health record responsive to receipt of the acknowledgement.

40. The method of claim 39, wherein opening the temporary, unresolved patient health record comprises opening a local version of the source patient health record.

41. The method of claim 39, wherein opening the temporary, unresolved patient health record comprises creating the temporary, unresolved patient health record when the requested portion of the source patient health record is not available locally.

42. The method of claim 39, wherein receiving the indication that the patient health record has been resolved in accordance with the resolution criteria comprises determining whether the temporary, unresolved patient health record can be matched to a source patient health record in the patient health record repository.

43. An article comprising a machine-accessible medium having stored thereon instructions that, when executed by a machine, cause the machine to:
provide an asynchronous mode of operation in a client device responsive to an unavailability of a synchronous connection to a patient health record;
open a temporary, unresolved patient health record;
receive a modification to a portion of the temporary, unresolved patient health record to create a modified, temporary unresolved patient health record;
communicate the modified, temporary, unresolved patient health record to a patient health record repository for resolution;
receive an acknowledgement of resolution of the patient health record, the acknowledgment being an indication that the patient health record has been resolved in accordance with a resolution criteria; and
delete the modified, temporary unresolved patient health record responsive to receipt of the acknowledgement.

44. The article of claim 43, having further instructions that, when executed by the machine, cause the machine to open a local version of the source patient health record.

45. The article of claim 43, having further instructions that, when executed by the machine, cause the machine to create the temporary, unresolved patient health record when the requested portion of the source patient health record is not available locally.

46. The article of claim 43, having further instructions that, when executed by the machine, cause the machine to determine whether the temporary, unresolved patient health record can be matched to a source patient health record in the patient health record repository.

47. A method of managing asynchronous patient data in a healthcare setting including a client device operable in an asynchronous mode to create temporary, unresolved patient health record data comprising:
receiving a temporary, unresolved patient health record from a client device;
determining whether the temporary, unresolved patient health record can be matched to the source patient health record in a patient health record repository;
creating a new source patient health record for the temporary, unresolved patient health record and deleting the temporary, unresolved patient health record if a match for the temporary, unresolved patient health record is not found in the patient health record repository;
updating the patient health record based upon the temporary, unresolved patient health record; and
communicating an acknowledgment to the client device.

48. The method of claim 47, wherein updating the patient health record comprises identifying a data conflict between the source patient health record and the temporary, unresolved patient health record if a match for the temporary, unresolved patient health record is found in the patient health record repository, and resolving the data conflict.

49. The method of claim 48, wherein resolving the data conflict comprises invoking a conflict resolution rule to resolve the data conflict.

50. The method of claim 48, wherein resolving the data conflict comprises submitting the temporary, unresolved patient health record to a resolution work queue for later evaluation by a user.

51. An article comprising a machine-accessible medium having stored thereon instructions that, when executed by a machine, cause the machine to:
receive a temporary, unresolved patient health record from a client device;
determine whether the temporary, unresolved patient health record can be matched to the source patient health record in a patient health record repository;
create a new source patient health record for the temporary, unresolved patient health record and delete the temporary, unresolved patient health record if a match for the temporary, unresolved patient health record is not found in the patient health record repository;
update the patient health record based upon the temporary, unresolved patient health record; and
communicate an acknowledgment to the client device.

52. The article of claim 51, having further instructions that, when executed by the machine, cause the machine to identify a data conflict between the source patient health record and the temporary, unresolved patient health record if a match for the temporary, unresolved patient health record is found in the patient health record repository, and resolve the data conflict.

53. The article of claim 52, having further instructions that, when executed by the machine, cause the machine to invoke a conflict resolution rule to resolve the data conflict.

54. The article of claim 52, having further instructions that, when executed by the machine, cause the machine to submit the temporary, unresolved patient health record to a resolution work queue for later evaluation by a user.
